(19) United States
(12) Patent Application Publication
(10) Pub. No.: US 2013/0335601 A1
(43) Pub. Date: Dec. 19, 2013

(54) IMAGING APPARATUS WHICH SUPPRESSES FIXED PATTERN NOISE GENERATED BY AN IMAGE SENSOR OF THE APPARATUS

(71) Applicant: DENSO CORPORATION, Kariya-city (JP)

(72) Inventors: Kentarou SHIOTA, Nagoya (JP); Toshikazu MURAO, Obu-shi (JP); Takayuki KIMURA, Kariya-shi (JP)

(21) Appl. No.: 13/916,876

(22) Filed: Jun. 13, 2013

(30) Foreign Application Priority Data
Jun. 13, 2012 (JP) 2012-133869

(51) Int. Cl. H04N 5/217

(52) U.S. Cl. CPC H04N 5/2173
USPC 348/247

(57) ABSTRACT

An imaging apparatus detects and registers fixed-noise pixels as those pixels of the image sensor which produce fixed pattern noise, and includes an optical element which disperses light that is incident on the image sensor. The detection is performed by identifying isolated high-luminance pixels within captured images and, for each isolated high-luminance pixel, evaluating the luminance values of peripherally adjacent pixels. A judgement is made as to whether an isolated high-luminance pixel is a fixed-noise pixel based upon comparing luminance values of the peripherally adjacent pixels with a predetermined threshold value, the judgement preferably being performed only while images are captured during hours of darkness.

### CROSS-REFERENCE TO RELATED APPLICATIONS

This application is based on and incorporates herein by reference Japanese Patent Application No. 2012-133869 filed on Jun 13, 2012.

### BACKGROUND OF THE INVENTION

1. Field of Application

The present invention relates to an imaging apparatus having a function for suppressing fixed pattern noise that is generated by an image sensor of the apparatus.

2. Background Technology

Fixed pattern noise signifies noise which occurs as an unchanged pattern within each of successive frames (expressing respective captured images) of image data produced by a digital camera. The fixed pattern noise results from one or more of the array of photo-sensors of the image sensor which are defective. These are caused by manufacturing deviations of the image sensor, and each defective photo-sensor continuously produces a high luminance output value, irrespective of the intensity of light that is incident thereon.

Various proposals have been made for removing such fixed pattern noise, as in Japanese patent publication No. 2006-140982. That patent proposes a method whereby image data of a plurality of successive frames, obtained from an image sensor, are accumulated, and whereby the fixed pattern noise is removed based upon spatial high-frequency components expressed in the accumulated image data. However with such a method, it is necessary to provide large-scale memory resources for storing the accumulated image data, and it is not possible to achieve a high speed of detecting the fixed pattern noise.

### SUMMARY

Hence it is desired to overcome the above problem, by providing an imaging apparatus having a function whereby the fixed pattern noise can be quickly detected and suppressed while using only small-scale memory resources.

The invention is applicable to an imaging apparatus having an optical system which incorporates an optical dispersion element such as an optical low-pass filter, for effecting dispersion of incident light beams entering the optical system, and having an image sensor formed with an array of photo-sensors respectively positioned to receive dispersed incident light beams from the optical dispersion element. The image sensor is controlled to capture an image data frame, which is formed of respective luminance values produced from the photo-sensors, and which expresses a captured image of an external scene.

To achieve the above objectives, the imaging apparatus further incorporates extraction circuitry, for processing the image data frame to identify high-luminance photo-sensors, i.e., photo-sensors producing respective luminance values exceeding a first predetermined threshold value, and to identify isolated ones of these high-luminance photo-sensors, i.e., which are isolated from all other high-luminance photo-sensors within the image data frame. The imaging apparatus further incorporates judgement circuitry configured for judging, for each of the isolated high-luminance photo-sensors, whether that photo-sensor is a fixed-noise photo-sensor, i.e., which is fixedly producing a high value of luminance irrespective of the intensity of light falling thereon, and so produces fixed pattern noise. This judgement is based upon a relationship between a second threshold value (lower than the first threshold value) and respective luminance values of a set of photo-sensors which are located peripherally adjacent to the isolated high-luminance photo-sensor and so may receive dispersed light which falls also upon that high-luminance photo-sensor.

The judgement is preferably executed only when the imaging apparatus is capturing images of an external (outdoors) scene during hours of darkness.

Furthermore preferably, the judgement circuitry judges that an isolated high-luminance photo-sensor is a fixed-noise photo-sensor when each of the luminance values of the peripherally adjacent photo-sensors of the isolated high-luminance photo-sensor is less than the second predetermined threshold value. However it would be also possible to judge that an isolated high-luminance photo-sensor is a fixed-noise photo-sensor when the average of the luminance values of the peripherally adjacent photo-sensors is less than the second predetermined threshold value, or when the sum total of the luminance values of the peripherally adjacent photo-sensors is less than the second predetermined threshold value.

Such an imaging apparatus further incorporates image data correction circuitry. This removes the fixed pattern noise by subtracting, from each luminance value produced from the fixed-noise photo-sensors in each of the image data frames, a correction amount corresponding to that fixed-noise photo-sensor. The correction amount corresponding to a fixed-noise photo-sensor is derived based upon (preferably, by averaging) luminance values which have been obtained from that photo-sensor in respective ones of a plurality of previously-captured image data frames.

The imaging apparatus preferable includes a rewritable memory such as an EEPROM, for storing luminance history data in respective records corresponding to each of the fixed-noise photo-sensors, for use in calculating the corresponding correction amount. Each record contains the position coordinates of the fixed-noise photo-sensor, and the luminance history data (luminance values previously produced from that photo-sensor in respective image data frames), with the corresponding correction amount being calculated as the average of the luminance history data values.

Preferably the luminance history data of each fixed-noise pixel is periodically updated, by adding thereto a luminance value produced from the corresponding fixed-noise photo-sensor in each newly captured image data frame, up to the current point in time.

Such an imaging apparatus may advantageously be installed in a motor vehicle, to capture images of a region ahead of the vehicle, for use in detecting objects such as other vehicles. In that case, the imaging apparatus may further include vehicle light detection circuitry configured for detecting the tail lamps or headlamps of such other vehicles when these appear within the images captured by the image sensor, with the detection being executed based on contents of the corrected image data frames.

### BRIEF DESCRIPTION OF THE DRAWINGS

FIG. 1 is a block diagram illustrating the general configuration of a vehicle control system which incorporates an embodiment of an imaging apparatus;

FIG. 2 is a timing diagram for illustrating processing which is applied by a processing unit of the embodiment to each of successive frames of video data;

FIGS. 3A to 3D illustrate luminance values produced when dispersed light beams are incident on a set of mutually adjacent photo-sensors of an image sensor;

FIG. 4 is a diagram illustrating luminance values produced when one of a set of mutually adjacent photo-sensors is a fixed-noise photo-sensor;

FIG. 5 is a flow diagram showing an overall flow of noise removal processing and of learning processing for identifying fixed-noise photo-sensors;

FIG. 6 is a flow diagram of noise removal processing executed by the processing unit of the embodiment;

FIG. 7 conceptually illustrates a noise map which is held in a rewritable memory of the embodiment;

FIG. 8 is a flow diagram of noise learning processing for identifying fixed-noise photo-sensors, executed by the processing unit of the embodiment;

FIG. 9 illustrates a position relationship between a judgement object pixel and a set of peripherally adjacent photo-sensors;

FIG. 10 is a flow diagram of group labeling processing which is executed in the noise learning processing; and

FIG. 11 is a flow diagram of processing for extracting isolated high-luminance photo-sensors, which is executed in the noise learning processing.

### DESCRIPTION OF PREFERRED EMBODIMENTS

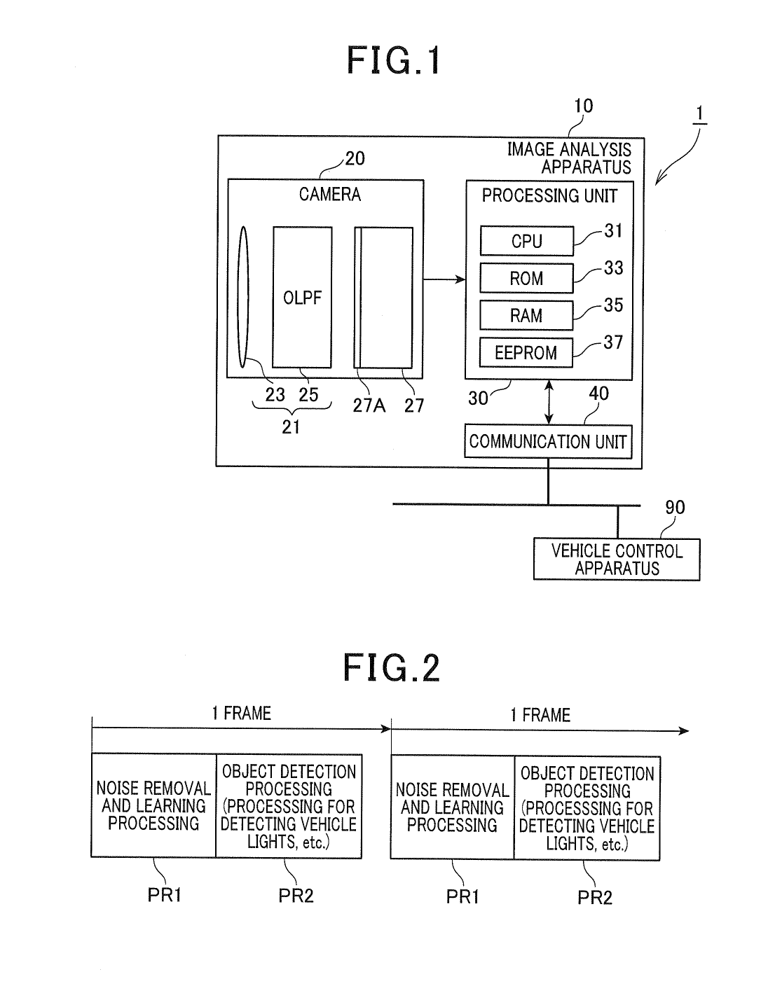

FIG. 1 shows the general configuration of a vehicle control system 1, which incorporates an image analysis apparatus 10 and a vehicle control apparatus 90, which are connected for data communication via an intra-vehicle network. The image analysis apparatus 10 includes a digital video camera (referred to in the following simply as a camera) 20 which captures successive images (as image data of successive video signal frames) of a region ahead of the host vehicle, and a processing unit 30. The latter is essentially constituted by a microcomputer as described hereinafter, with the functions of the processing unit 30 being performed by executing a stored program. These functions include control of the camera 20 and analysis of the image data obtained from the camera 20, for purposes including detecting the presence of objects located ahead of the host vehicle. The detection results are transmitted to the vehicle control apparatus 90. The image analysis apparatus 10 further includes a communication unit 40 (communication interface) which controls bidirectional transfer of data between the image analysis apparatus 10 and the vehicle control apparatus 90 through the intra-vehicle network.

The vehicle control apparatus 90 performs control of the host vehicle (e.g., control of inter-vehicle separation distance) based on the aforementioned detection results obtained from the image analysis apparatus 10. In addition, during night driving, the vehicle control apparatus 90 controls the direction of the headlamp beams of the host vehicle (i.e., controls high beam/low beam switching).

As shown, the camera 20 includes an optical system 21 which receives external incident light, and an image sensor 27 which produces image data in accordance with incident light from the optical system 21. Specifically, the image sensor 27 is controlled to generate the image data as successive frames, each frame consisting of respective luminance values obtained from an array of photo-sensors.

For brevity of description, these photo-sensors are referred to in the following as pixels, and the detection signal level produced by a photo-sensor in accordance with received light intensity is referred to as the luminance value produced by the photo-sensor.

The optical system 21 consists of a lens 23 and an optical low pass filter (sometimes referred to as an anti-aliasing filter) 25. The optical low pass filter 25 serves to eliminate certain spatial high-frequency components from the externally received incident light, before the light falls on the image sensor 27. This is done through dispersion of the external incident light, which with this embodiment is performed by splitting each incident light beam into four separate beams, as is well known in this field of technology.

The image sensor 27 includes a color filter array 27A, formed of red (R), green (G) and (B) filters located over corresponding ones of the array of pixels of the image sensor 27. Pixels respectively corresponding to these R, G, B filters are referred to in the following as R, G and B pixels. This embodiment utilizes a CMOS (complementary metal-oxide-semiconductor) image sensor, however the invention is equally applicable to other types of sensor such as a CCD (charge coupled device) image sensor.

In each of successive frame intervals, the image sensor 27 is controlled by the processing unit 30 to produce image data consisting of respective luminance values from the pixels. Due to the presence of the color filter array 27A, the image data constitute color image data, i.e., the luminance values from a set of respectively adjacent R, G, B pixels express both luminance and chrominance information for a part of a captured image.

The image data of successive frames, expressing respective images of the region ahead of the host vehicle, are supplied from the image sensor 27 to the processing unit 30.

In addition to performing overall control of the image analysis apparatus 10, the processing unit 30 analyzes the image data of respective frames obtained from the camera 20, for detecting objects located ahead of the host vehicle, such as persons or other vehicles. As stated above the processing unit 30 is basically a microcomputer, having a CPU 31, a ROM 33, a RAM 35 and an EEPROM (electrically erasable programmable memory) 37, i.e., a rewritable non-volatile memory. The functions of the processing unit 30 are performed by the CPU 31 through execution of a program which is held stored in the ROM 33.

By controlling the camera 20, the processing unit 30 periodically acquire images (expressed by respective image data frames) from the camera 20 showing a region ahead of the host vehicle. As illustrated in FIG. 2, during each frame interval, the processing unit 30 processes the currently acquired image data frame (i.e., the image data produced in the immediately preceding frame interval), with the processing being executed in two successive stages designated as the noise removal and learning processing PR1 and the object detection processing PR2 respectively. The noise removal and learning processing PR1 includes processing which is applied to the currently acquired image data frame for removal of noise (in particular, fixed pattern noise) to thereby obtain corrected image data. In addition, the noise removal and learning processing PR1 includes processing for learning (i.e., detecting and registering) any fixed-noise pixels (i.e., pixels producing fixed luminance values which result in the fixed pattern noise) which have not yet been registered, and for updating luminance history data which is stored for each of previously registered fixed-noise pixels.

The object detection processing PR2 is applied to the corrected image data of the currently acquired frame, for detecting objects located ahead of the host vehicle. Technology for implementing such detection is well known, so that detailed description is omitted herein. For example when the host vehicle is being operated at night (i.e., during the hours of darkness), the PR2 processing can be executed for detecting vehicle headlamps or tail lamps, appearing within the captured images expressed by the corrected image data.

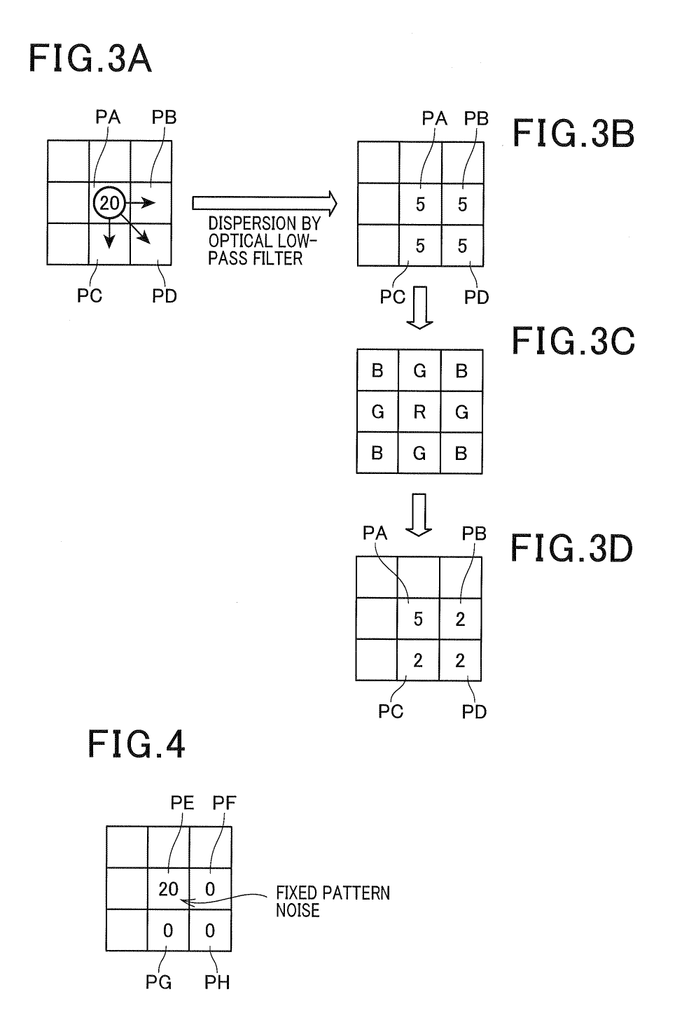

The principles of judgement applied for identifying the fixed-noise pixels will be described referring to the example of FIGS. 3A˜3D (illustrating the case in which a high-luminance pixel is a normal pixel) and the example of FIG. 4 (illustrating the case in which a high-luminance pixel is a fixed-noise pixel). In the example of FIG. 3A a beam of external light entering the camera 20 is dispersed by being split by the optical low pass filter 25 into four emergent light beams, which are assumed to be respectively incident on four mutually adjacent pixels PA, PB, PC and PD of the image sensor 27. It is assumed that no other dispersed light is incident on the pixels PB, PC, PD, i.e., that no other nearby pixel is producing a high luminance value.

It will also be assumed that red is the main color component of the incident light beam, as with light from a tail lamp of a vehicle, and that this is dispersed to fall only on the pixels PA, PB, PC and PD. If the color filter array 27A were removed, the pixels PA, PB, PC, PD would produce identical values of luminance in response to the dispersed light, as illustrated in FIG. 3B. However due to attenuation of the red component by the G, B color filters shown in FIG. 3C, the luminance values from the pixels PB, PC, PD pixels will each be lower than that from the R pixel PA, but will each be significantly greater than zero, as illustrated in FIG. 3D.

Referring now to FIG. 4, in a set of four mutually adjacent pixels PE, PF, PG, PH, the pixel PE is a fixed-noise pixel producing a fixed high value of luminance, and it is assumed that no dispersed light falls on any of the pixels PF, PG, PH (no other nearby pixel is producing a high luminance value). In that case, the peripherally adjacent pixels PF, PG, PH each produce a luminance value of zero or substantially zero.

This phenomenon is used by the embodiment as follows. When image data of successive frames are acquired from the image sensor 27 during the hours of darkness, then in each frame, each isolated high-luminance pixel (a pixel which produces a luminance value exceeding a predetermined threshold value and is spatially isolated from all other high-luminance pixels) is identified. A decision is then made as to whether the isolated high-luminance pixel is a fixed-noise pixel based upon the average luminance values of a set of peripherally adjacent pixels of the isolated high-luminance pixel.

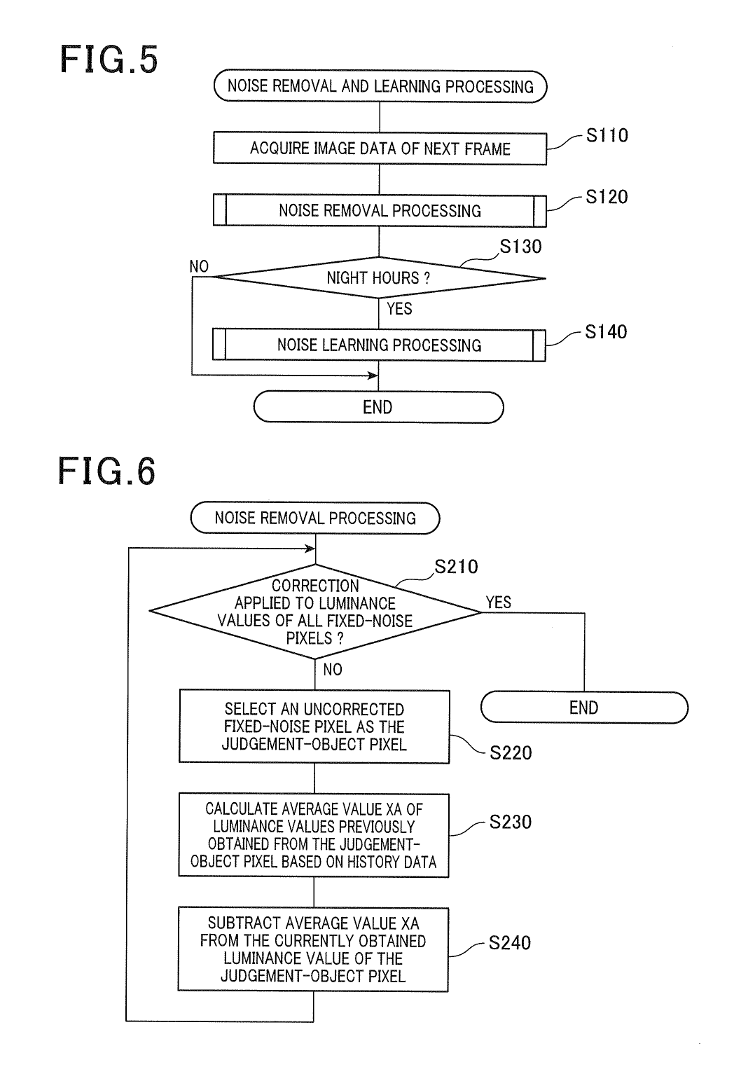

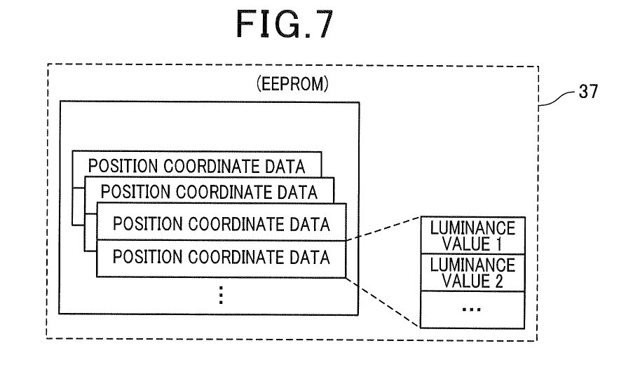

The noise removal and learning processing PR1 executed by the processing unit 30 will be described in greater detail referring first to the flow diagram of FIG. 5. Firstly (step S110), the processing unit 30 acquires the current image data (i.e., data of one frame, produced from the image sensor 27). Next in step S120, the processing unit 30 performs the noise removal processing shown in the flow diagram of FIG. 6. For each of respective pixels which have been registered as fixed-noise pixels, a corresponding set of previously obtained luminance values has been stored as luminance history data in a memory map referred to as a noise map, stored in the EEPROM 37. The noise map is conceptually illustrated in FIG. 7. The luminance value which is obtained for each fixed-noise pixel in the current image data is corrected, by subtracting from it a correction amount, which is the average of the corresponding luminance history data. The current image data is thereby processed to obtain corrected image data, having the fixed pattern noise suppressed.

More specifically, referring to FIG. 6, when the noise removal processing is commenced, the processing unit 30 judges whether noise removal processing has been applied to all of the fixed-noise pixels which have already been registered in the noise map (step S210). For each registered pixel, corresponding coordinate data (i.e., coordinates of position within the pixel array of the image sensor 27) and luminance history data are stored as a record in the noise map. The luminance history data recorded for a fixed-noise pixel consists of luminance values which have been successively obtained from that pixel (i.e., as successive updating samples, from respective image data frames) when images are being captured by the camera 20 during the hours of darkness, up to the present time.

If it is judged that noise removal processing has been applied to all of the fixed-noise pixels which have been registered in the noise map (YES in step S210), execution of the noise removal processing routine is ended, while otherwise (NO in step S210) another fixed-noise pixel is selected (step S220). Next (step S230) based on the luminance history data for the pixel which is selected to be processed (referred to in the following as the processing-object pixel), a correction amount XA is calculated as the average of the values in the luminance history data of the processing-object pixel. Designating the luminance value obtained from the processing-object pixel in the current image data as the X, this is then corrected by subtracting from it the corresponding correction amount XA (step S240), to obtain a corresponding corrected luminance value (X−XA). Step S210 and the subsequent steps are then again executed.

In that way, corrected (i.e., fixed pattern noise-removed) image data is obtained from the current image data, by applying the processing of steps S230, S240 to the currently obtained luminance values of each of the fixed-noise pixels which have been registered in the noise map.

Upon completion of the noise removal processing (YES decision in step S210), the processing unit 30 then executes step S130 of FIG. 5, to judge whether the vehicle is currently operating during the hours of darkness. If it is not (NO decision), this execution of the noise removal and learning processing routine PR1 is ended, without executing the noise learning processing. If so (YES decision in step S130), noise learning processing (step S140) is executed, then this execution of the noise removal and learning processing PR1 is ended.

The decision as to whether the host vehicle is currently operating at night can for example be made based upon whether or not the total luminance of each image data frame (or the average of the respective luminance values of the image data frame) is above a predetermined threshold value. In that case, when the total luminance (or average luminance value) exceeds the predetermined threshold value, a NO decision is reached in step S130 of FIG. 5, while otherwise a YES decision is made in step S130, and the noise learning processing is executed. However other methods for distinguishing between daylight and night time operation could be envisaged.

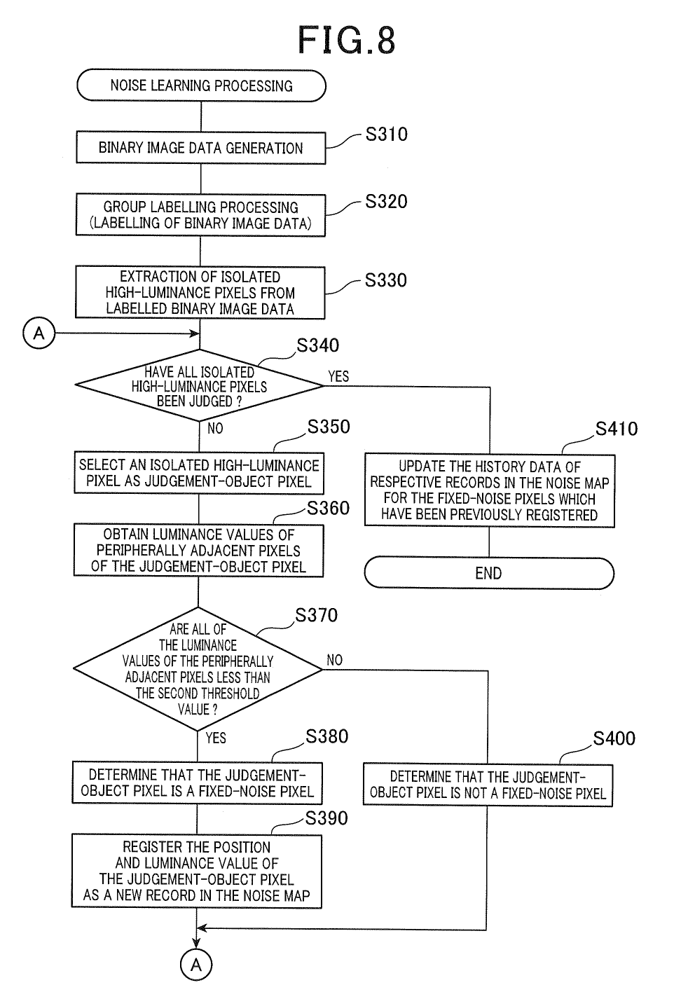

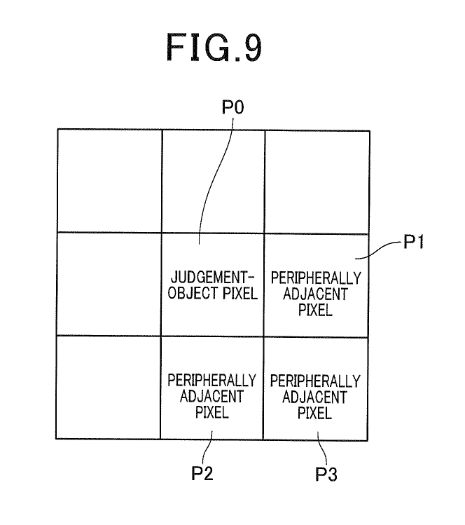

Referring to the flow diagram of the noise learning processing shown in FIG. 8, the processing unit 30 first (step S310) converts the corrected image data (obtained by the noise removal step S120 of FIG. 5 above) to binary image data. Specifically, the corrected luminance values from the current image data frame, corresponding to respective pixels of the image sensor 27, are converted to binary values by assigning a 1 or a 0 value to each corrected luminance value in accordance with whether or not it exceeds a predetermined first threshold value. The pixels for which the corresponding luminance value is assigned the 1 value are referred to in the following as the high-luminance pixels. It should be emphasized that the binary conversion processing of step S310 is applied to corrected image data, obtained by the noise removal processing of step S120 of FIG. 5.

Next, (step S320) the processing unit 30 applies group labeling to the binary image data. Here “labeling” signifies attaching individual identifiers (labels) to respective groups of pixels. Each of the groups consist only of pixels which have been assigned the value 1, and each group is formed of a single pixel, or of a plurality of continuously adjacent pixels (i.e., which are each positioned immediately adjacent to at least one other pixel of that group). The same label is assigned in common to each of the pixels of the group. Here, “immediately adjacent” signifies immediately above or immediately below, or immediately to the left side or to the right side, or diagonally immediately adjacent. Thus, the groups correspond to respective high-luminance regions within the currently acquired image data frame.

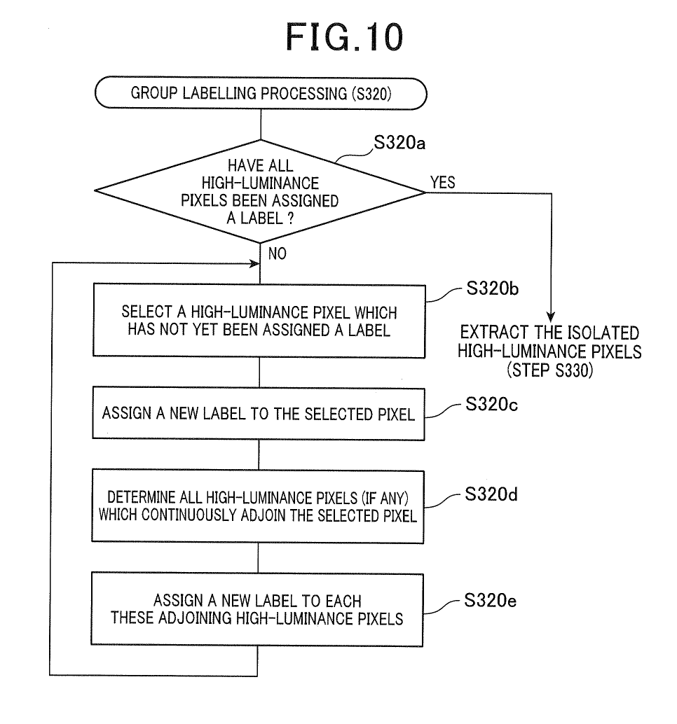

The flow diagram of FIG. 10 shows details of the labeling processing contents. As shown, so long as one or of the high-luminance pixels has not yet been assigned a label (NO decision in step S320a), a high-luminance pixel is selected (step S320b), and is assigned a new label (i.e., which has not yet been assigned to any other pixels) in step S320c. A search is then made to form all high-luminance pixels, if any, which are continuously adjacent (as defined above) to the selected high-luminance pixel (step S320d). The new label is then assigned to each of these high-luminance pixels (step S320e), thereby attaching the label to a new group. When all of the high-luminance pixels have been assigned a label (YES in step S320a), step S330 of FIG. 8 is then executed. Although with this embodiment the grouping is performed only in accordance with luminance values, it may be preferable to perform the grouping in accordance with pixel color, i.e., to select groups of high-luminance R pixels, groups of high-luminance G pixels and groups of high-luminance B pixels.

Next (step S330), processing is executed for extracting high-luminance isolated pixels. For each of the labels, the number of pixels which have been assigned to that label is counted, and each label for which the count value is 1 is extracted. In that way, each of respective isolated high-luminance pixels (high-luminance regions constituted by a single pixel) are extracted (identified), i.e., with each isolated high-luminance pixel producing a luminance value which exceeds the first threshold value and being spatially isolated from all other high-luminance pixels.

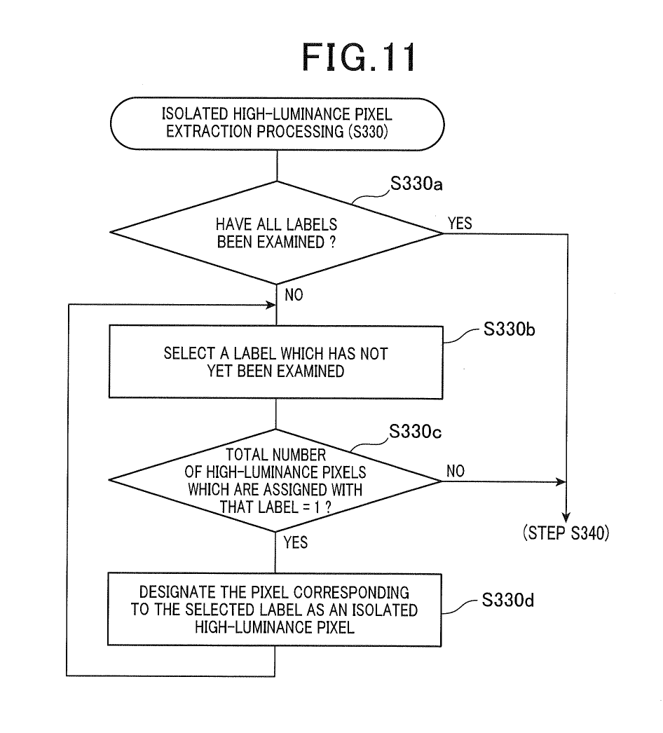

The flow diagram of FIG. 11 shows details of the labeling processing contents. As shown, if all of the assigned labels have not yet been examined (NO in step S330a), an assigned label is selected (step S330b). The total number of high-luminance pixels which are assigned with that label is then counted. If it is judged that the label is assigned to only a single high-luminance pixel (YES in step S330c), that pixel is designated as being an isolated high-luminance pixel (step S330d). If the selected label has been assigned to a group containing a plurality of high-luminance pixels (NO in step S330c), operation returns to step S330a. When all of the labels have been examined (YES in step S330a), step S340 of FIG. 8 is then executed. Referring again to FIG. 8, following step S330, the processing unit 30 determines in step S340 whether all of the high-luminance isolated pixels identified in step S330 have been judged to find if they are fixed-noise pixels. If one or more such isolated pixels remain to be judged (NO decision in step S340), step S350 is then executed to select another high-luminance pixel as a judgement-object pixel, while otherwise (YES decision), step S410 is executed.

Following step S350, in step S370, the processing unit 30 refers to the luminance values (within the pre-correction image data of the currently acquired frame) of a set of pixels which are peripherally adjacent to the judgement-object pixel, such as the pixels at the positions PB, PC, PD with respect to pixel PA in the above example of FIGS. 3A˜3D. The term “pre-correction image data” signifies the image data acquired in step S110 of FIG. 5 above, i.e., the luminance values of the current image data frame, prior to executing the noise removal processing of step S120.

In step S370, the processing unit 30 judges whether all of these peripherally adjacent pixels produce luminance values, within the pre-correction image data, which are less than a predetermined second threshold value.

The second threshold value is made sufficiently lower than the first threshold value, used for converting the image data to binary data in step S310 above. The assignees of the present invention have found by experiment that a suitable value can be determined for the second threshold value, whereby those isolated high-luminance pixels which are fixed-noise pixels can be reliably detected as described in the following.

If it is determined that the respective luminance values of all of the peripherally adjacent pixels of the judgement-object pixel are below the second threshold value (YES decision in step S370) then the processing unit 30 judges (step S380) that the judgement object pixel is a fixed-noise pixel as defined above. In that case, a new record is established in the noise map of the EEPROM 37, containing the position coordinates of the judgement object pixel and the currently obtained (uncorrected) luminance value of the judgement object pixel, as an initial value in the luminance history data for that pixel (step S390).

Following step S390, operation then returns to step S340, and the above series of steps S350 to S390 are repeated for another isolated high-luminance pixel, as the judgement object pixel, if all of the isolated high-luminance pixels have not yet been judged (NO decision in step S340).

If it is determined (step S400) that the judgement object pixel is not a fixed-noise pixel, steps S380, S390 are skipped and operation returns to step S340.

In that way, a sequence of steps commencing at step S350 is executed for each of the isolated high-luminance pixels that are extracted from the binary image data and which (since their high luminance values occur within the corrected image data) have not been previously registered as fixed-noise pixels. If it is judged that an isolated high-luminance pixel is a newly detected fixed-noise pixel, then the currently acquired (pre-correction) luminance value obtained for that pixel is stored in a new record (luminance history data and position coordinates) which is established in the noise map, corresponding to that pixel.

When all of the isolated high-luminance pixels have been judged (YES in step S340), step S410 is then executed, to update the luminance history data for each of respective fixed-noise pixels which have been previously recorded, by adding to the luminance history data the corresponding luminance value obtained from the current image data frame. This execution of the noise learning processing routine is then ended.

As a result of the processing of FIG. 8, the luminance history data of each fixed-noise pixel consists of stored luminance values which have been successively obtained for that pixel up to the current point in time, and which have each been captured by the camera 20 during the hours of darkness.

For each of the fixed-noise pixels, the correction amount XA corresponding to that pixel is calculated as the average of the corresponding luminance history data, in step S230 of the noise removal processing routine of FIG. 6, In step S240, the correction amount XA is subtracted from the currently acquired (pre-correction) luminance value obtained for that pixel, to obtain a corrected luminance value for that pixel. A corrected image data frame, with fixed pattern noise excluded, is thereby obtained from the currently acquired image data frame.

The above features of this embodiment can be summarized as follows. The image sensor 27 captures successive images (as respective image data frames) of a region ahead of the host vehicle, from incident light received by the optical system 21, with the incident light being dispersed by the optical low pass filter 25 in the optical system 21. After the image data of the currently captured image have been subjected to correction (noise removal) processing, the processing unit 30 processes the array of (corrected) luminance values of the captured image, to extract high-luminance pixels as pixels having a luminance value above a first threshold value. The processing unit 30 then extracts (identifies) each of the high-luminance pixels which is an isolated high-luminance pixel, i.e., is isolated from all other high-luminance pixels (steps S310˜330).

The processing unit 30 then processes each of the high-luminance isolated pixels in succession as a judgement object pixel, for judging whether the judgement object pixel is a fixed-noise pixel (as defined above), with the judgement being based upon the respective (pre-correction) luminance values of a set of peripherally adjacent pixels of the judgement-object pixel. (steps S340˜400). Specifically, if all of these luminance values are below the second threshold value, it is judged that the isolated high-luminance pixel is a fixed-noise pixel.

With the above embodiment, it becomes possible to accurately and rapidly detect fixed-noise pixels without requiring that large amounts of image data be stored for use in such detection, as is required in the prior art. Hence, only small amounts of memory resources are required.

Furthermore since detection of the fixed-noise pixels can be achieved rapidly, fixed pattern noise can be quickly removed from the image data, to provide noise-free corrected image data. If not removed, the fixed pattern noise can result in errors in judging sources of light which appear in the captured images. In particular, if the uncorrected image data contains luminance values from fixed-noise pixels which are red (R) pixels, these could be erroneously interpreted as tail lamps of preceding vehicles. The above embodiment enables this problem to be prevented.

Thus, operations such as detecting tail lamps or headlamps of other vehicles, executed in the object detection processing PR2, can be reliably performed, enabling appropriate vehicle control to be achieved based on results of such detection.

With the above embodiment, for each of the fixed-noise pixels, the luminance values which are obtained from that pixel in successive image data frames are sequentially stored as the luminance history data for the pixel, i.e., as successive luminance samples, for use in calculating the correction amount which is to be applied for the fixed-noise pixel (S410). The correction amount XA is calculated as the average of the luminance values in the luminance history data for the fixed-noise pixel, i.e., values which have been acquired from images captured during the hours of darkness. A corrected luminance value is then obtained by subtracting the correction amount XA from the luminance value corresponding to that pixel which is currently acquired from the image sensor 27.

Hence with the above embodiment the fixed pattern noise component can be accurately removed from the image data produced from the image sensor 27. Specifically, although variations will occur in the luminance values successively obtained for a fixed-noise pixel in successive frames (i.e., the values which update the corresponding luminance history data, in successive executions of step S410 of FIG. 8), the corresponding correction amount (average value of the luminance history data) will become increasingly accurate as time elapses. The object detection processing PR2 can thereby be performed reliably, due to effective suppression of the fixed pattern noise.

It should be noted that it would be possible to obtain the correction amount XA of a fixed-noise pixel by applying weighted averaging. Specifically, the more recently the luminance values have been recorded in the luminance history data of the fixed-noise pixel, the greater would be the weight given to these luminance values in the averaging calculation.

It should further be noted that the invention is not limited to the above embodiment, and that various modifications or alternative forms of the embodiment may be e envisaged which fall within the scope of the invention as set out in the appended claims. For example with the above embodiment, the decision as to whether an isolated pixel is a fixed-noise pixel is made based upon whether all of the luminance values of a set of peripherally adjacent pixels of that isolated high-luminance pixel are below a second threshold value, which is lower than the first threshold value (used in extracting the high-luminance isolated pixels). However it Would be equally possible to make the decision as to whether a high-luminance isolated pixel is a fixed-noise pixel based upon whether the average luminance value of the peripherally adjacent pixels is below a second threshold value, or based upon whether the total of the respective luminance value of the peripherally adjacent pixels is below a second threshold value.

Furthermore with the above embodiment, an optical low pass filter is utilized which operates by splitting an incident light beam into four dispersed light beams, such that the four dispersed light beams may become incident on four mutually adjacent pixels. However it would be equally possible to utilize an optical low pass filter which splits an incident light beam into a pair of dispersed light beams. In that case, the judgement as to whether an isolated high-luminance pixel is a fixed-noise pixel could be made based on the luminance value of a single adjacent pixel (such as PB or PC in the example of FIGS. 3A˜3D above).

Furthermore with the above embodiment, luminance values obtained for a fixed-noise pixel are successively stored as the luminance history data corresponding to that pixel, and are used to calculate a corresponding correction amount XA. However it would be equally possible to add each newly obtained luminance value to a total luminance value (i.e., each time step S410 of FIG. 8 is executed), and store only that total luminance value and the number of updatings, and to use these to calculate the correction amount XA. This would enable the required memory resources to be further reduced by comparison with the prior art.

Furthermore with the above embodiment a fixed value is set for the second threshold value, used in judging whether an isolated high-luminance pixel (the judgement-object pixel) is a fixed-noise pixel. However it would be equally possible to determine the second threshold value in accordance with the luminance value of the judgement object pixel. Specifically, the second threshold value could be set in accordance with the difference between the luminance value of the judgement object pixel and a luminance value of peripherally adjacent pixels (e.g., difference between the luminance value of the judgement object pixel and the average luminance value of a set of peripherally adjacent pixels).

The following relationships exist between contents of the above embodiment and the appended claims. In executing the program which is held in the ROM 33 to perform the operation steps S330a to S330d shown in FIG. 11, the processing unit (microcomputer) 30 corresponds to extraction circuitry for extracting (i.e., identifying) isolated high-luminance photo-sensors as recited in the claims. Similarly, in executing the stored program to perform the steps S350 to S380 shown in FIG. 8, the processing unit 30 corresponds to judgement circuitry for judging whether an isolated high-luminance photo-sensor is a fixed-noise photo-sensor, as recited in the claims. Similarly, in executing the stored program to perform the steps S210 to S240 shown in FIG. 6, the processing unit 30 corresponds to correction circuitry for obtaining corrected image data frames, as recited in the claims. The EEPROM 27 corresponds to a non-volatile rewritable memory as recited in the claims.

What is claimed is:

1. An imaging apparatus comprising
an optical system incorporating an optical dispersion element, the optical dispersion element disposed for effecting dispersion of incident light entering the optical system, and
an image sensor comprising an array of photo-sensors disposed to receive dispersed incident light from the optical system, for capturing an image data frame, the image data frame comprising respective luminance values of the photo-sensors and expressing a captured image of an external scene,
wherein the imaging apparatus comprises: p2 extraction circuitry configured for processing the image data frame for identifying isolated high-luminance photo-sensors as respective photo-sensors each producing a luminance value exceeding a first predetermined threshold value and each spatially separated from all other photo-sensors producing a luminance value exceeding the first threshold value, and
judgement circuitry configured for judging, for each of the isolated high-luminance photo-sensors, whether the isolated high-luminance photo-sensor is a fixed-noise photo-sensor producing a fixed high value of luminance.

2. The imaging apparatus as claimed in claim 1 wherein the judgement circuitry judges whether an isolated high-luminance photo-sensor is a fixed-noise photo-sensor based upon respective luminance values of a corresponding set of one or more photo-sensors located peripherally adjacent to the isolated high-luminance photo-sensor.

3. The imaging apparatus as claimed in claim 2, wherein the judgement circuitry determines that an isolated high-luminance photo-sensor is a fixed-noise photo-sensor when each of the luminance values of the corresponding peripherally adjacent photo-sensors is judged to be less than a second predetermined threshold value.

4. The imaging apparatus as claimed in claim 2, wherein the judgement circuitry determines that an isolated high-luminance photo-sensor is a fixed-noise photo-sensor when an average of the luminance values of the corresponding peripherally adjacent photo-sensors is judged to be less than a second predetermined threshold value.

5. The imaging apparatus as claimed in claim 2, wherein the judgement circuitry determines that an isolated high-luminance photo-sensor is a fixed-noise photo-sensor when a total of the luminance values of the corresponding peripherally adjacent photo-sensors is judged to be less than a second predetermined threshold value.

6. The imaging apparatus as claimed in claim 1 wherein image data frames are captured successively by the image sensor, and comprising image data correction circuitry configured for subtracting a corresponding correction amount from the luminance value of each of the fixed-noise photo-sensors in each of the image data frames, to thereby obtain corrected image data frames having a fixed pattern noise component excluded therefrom, the correction amount corresponding to a fixed-noise photo-sensor being derived based upon luminance values obtained for the fixed-noise photo-sensor in respective ones of a plurality of image data frames previously produced from the image sensor.

7. The imaging apparatus as claimed in claim 6, wherein the extraction circuitry extracts the isolated high-luminance pixels based on processing the corrected image data frames.

8. The imaging apparatus as claimed in claim 6 comprising a non-volatile rewritable memory, wherein the image data correction circuitry:
stores luminance history data in the rewritable memory with respect to each of the fixed-noise photo-sensors, the luminance history data of a fixed-noise photo-sensor comprising a plurality of luminance values previously obtained for the fixed-noise photo-sensor from respective image data frames, and
derives the correction amount corresponding to a fixed-noise photo-sensor based upon the luminance history data corresponding to the fixed-noise photo-sensor.

9. The imaging apparatus as claimed in claim 8 wherein,
for each of the fixed-noise photo-sensors, the image data correction circuitry updates the luminance history data corresponding to the fixed-noise photo-sensor each time that an image data frame is newly captured by the image sensor, and
the updating is executed by adding to the corresponding luminance history data a luminance value produced from the fixed-noise photo-sensor, contained in the newly captured image data frame.

10. The imaging apparatus as claimed in claim 9, wherein:
the judgement circuitry executes the judgement of the isolated photo-sensors only while the captured images are images of an outdoor scene, captured during hours of darkness; and,
the image data correction circuitry updates the luminance history data only while the captured images are images of an outdoor scene, captured during hours of darkness.

11. The imaging apparatus as claimed in claim 9 wherein, for each of the fixed-noise photo-sensors, the image data correction circuitry derives the correction amount corresponding to the fixed-noise photo-sensor based upon a plurality of luminance values from the luminance history data corresponding to the fixed-noise photo-sensor, including a most recently updated luminance value.

12. The imaging apparatus as claimed in claim 9 wherein, for each of the fixed-noise photo-sensors, the image data correction circuitry derives the correction amount corresponding to the fixed-noise photo-sensor as an average value of at least a part of the luminance values of the luminance history data corresponding to the fixed-noise photo-sensor.

13. The imaging apparatus as claimed in claim 6, wherein:
the imaging apparatus is installed in a motor vehicle, disposed for capturing images of a region ahead of the vehicle;
the imaging apparatus further comprises vehicle light detection circuitry configured for detecting lights of other vehicles when such lights are expressed within the captured images, the detection being executed based on contents of the corrected image data frames;
the judgement circuitry executes judgement of the isolated photo-sensors only while the vehicle is operating during hours of darkness; and,
the image data correction circuitry updates the luminance history data only while the vehicle is operating during hours of darkness.
